(19) United States
(12) Patent Application Publication
(10) Pub. No.: US 2014/0283329 A1
(43) Pub. Date: Sep. 25, 2014

(54) METHOD FOR ADJUSTING THE POWER OF A VACUUM CLEANER FAN, CONTROL SYSTEM FOR IMPLEMENTING THE METHOD, AND VACUUM CLEANER HAVING SUCH A CONTROL SYSTEM

(71) Applicant: MIELE & CIE. KG, Guetersloh (DE)

(72) Inventor: Otto BRAUN, Bielefeld (DE)

(73) Assignee: MIELE & CIE. KG, Guetersloh (DE)

(21) Appl. No.: 14/219,045

(22) Filed: Mar. 19, 2014

(30) Foreign Application Priority Data
Mar. 20, 2013 (DE) 10 2013 102 847.0

(51) Int. Cl. A47L 9/28; H02P 7/24

(52) U.S. Cl. CPC A47L 9/2842; H02P 7/24
USPC 15/339; 318/481

(57) ABSTRACT

A method of adjusting the power of a vacuum cleaner fan comprising a vacuum switch having a single switching point includes using the vacuum switch to create a signal indicative of a vacuum pressure created by the vacuum cleaner fan. The method also includes filtering the signal to obtain a resulting signal, the resulting signal being a measure of the vacuum pressure. The method further includes using the resulting signal as a controlled variable for adjusting the fan power with an electronic control system.

### CROSS-REFERENCE TO RELATED APPLICATIONS

Priority is claimed to German Patent Application No. DE 10 2013 102 847.0, filed on Mar. 20, 2013, the entire disclosure of which is hereby incorporated by reference herein.

### FIELD

The present invention relates firstly to a method for adjusting the power of the fan of a vacuum cleaner. The present invention further relates to a control system for implementing the method, and finally also to a vacuum cleaner having a control system for carrying out the method.

### BACKGROUND

High-quality vacuum cleaners allow for automatic control of the suction power. The purpose of this is, on the one hand, to maintain the force required to push the floor nozzle at low levels and, on the other hand, to adapt the power to the floor covering to be cleaned. Control is performed as a function of the measured vacuum as the controlled variable, which is measured at a characteristic point, such as the floor nozzle or the suction connector. The vacuum may be measured using analog-output vacuum sensors, vacuum switches with two switching points, or vacuum switches with a single switching point. Adaptation of the fan power is accomplished, for example, using leading-edge phase angle control. In this case, a phase angle is used as the manipulated variable. The analysis of the sensor signals, the adjustment of the manipulated variable, as well as potential further measurements are usually performed by a microcontroller, hereinafter generally referred to as “electronic control system”.

Analog-output vacuum sensors have the advantage of allowing the deviation from the setpoint to be accurately measured at all times. Therefore, they allow for best control performance. In addition, they are fast and accurate. This advantage is counterbalanced by the relatively high cost of such an analog vacuum sensor. A more cost-effective variant is provided by vacuum switches with two switching points (or, alternatively, by two vacuum switches having different switching points): The setpoint of the controlled variable is between the two switching points (vacuum values), and the fan power can be reliably controlled into the desired target range. Thus, the selected power varies within the setpoint range between the two switching points. An even more cost-effective variant would be to use only one vacuum switch.

The older, not previously published European Patent Application No. 12401010.9 of the applicant proposes a design in which only one vacuum switch having a single switching point is used for adjusting the power of a vacuum cleaner fan. This patent provides that during a first operating phase, the control system of the vacuum cleaner determines, based on the switching point of the vacuum switch, characteristic parameters for determining an operating point of the vacuum cleaner fan. In the first operating phase, a manipulated variable for the fan power is adjusted such that the vacuum switch changes its state as soon as possible. The characteristic parameters for determining the operating point of the vacuum cleaner fan are derived from the time elapsed up to this switch state change and the fan power at the switch state change, more precisely a difference between a maximum power and the fan power at the switch state change. The operating point is approached under the control of the control system by inputting a corresponding manipulated variable. Subsequently, the manipulated variable is changed only slowly. In the process, the manipulated variable is, for example, gradually reduced until the vacuum switch opens. Then, the manipulated variable is gradually increased until the vacuum switch closes, etc. Accordingly, the fan power affected by the manipulated variable oscillates at a low frequency about the operating point of the vacuum cleaner fan.

### SUMMARY

In an embodiment, the present invention provides a method of adjusting the power of a vacuum cleaner fan comprising a vacuum switch having a single switching point. The method includes tapping off a signal via the vacuum switch. The method also includes filtering the tapped off signal to obtain a resulting signal, the resulting signal being a measure of the vacuum pressure created by the vacuum cleaner fan. The method further includes using the resulting signal as a controlled variable for adjusting the fan power with an electronic control system.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a vacuum cleaner having a vacuum cleaner fan and a control system for adjusting the power of the vacuum cleaner fan;

FIG. 2 shows the circuitry according to the present invention, which is associated with a vacuum switch having one switching point and allows the vacuum switch to be used as an analog vacuum sensor;

FIG. 3 shows an example of a signal that can be tapped off above a vacuum switch having a single switching point at a vacuum pressure close to the switching point;

FIG. 4 shows an example of a signal that can be tapped off at the output of the circuit shown in FIG. 2;

FIG. 5 is a simplified schematic diagram, in which a signal that can be tapped off at the output of the circuit shown in FIG. 2 is plotted as a function of the power of the vacuum cleaner fan, highlighting a region that can be considered a measurement range of the vacuum sensor;

FIG. 6 shows the signal of FIG. 5 with different regions resulting from the signal waveform;

FIG. 7 shows a circuit which is based on the principle depicted in FIG. 2 and includes a plurality of vacuum switches which each have exactly one switching point; and

FIG. 8 shows a signal similar to that shown in FIG. 5, but with a plurality of successive measurement ranges provided by a plurality of vacuum switches (FIG. 7).

### DETAILED DESCRIPTION

Anaspect of the present invention to provide a way of adjusting the power of a vacuum cleaner fan based on a vacuum switch having a single switching point In particular, an aspect of the present invention is to provide a method for adjusting the power of a vacuum cleaner fan that is not based on iterative approximation to the switching point of the vacuum switch.

In an embodiment, the present invention provides a method in which an electronic control system adjusts the fan power via a suitable manipulated variable as a function of a vacuum created by the vacuum cleaner fan, and a measure of the vacuum pressure is ascertained using a vacuum switch having a single switching point, where a signal that can be tapped off above the vacuum switch is filtered, in particular low-pass filtered, and a signal obtained after filtering is used as a measure of the vacuum pressure and as a controlled variable for adjusting the fan power.

An advantage of the solution proposed herein resides in the discovery that the signal that can be tapped off above the vacuum switch at a vacuum pressure close to the switching point of the vacuum switch, and, above all, the ON time of the pulses in the signal, are directly proportional to the pressure differential applied, and thus to the vacuum created by the vacuum cleaner fan. The vacuum conditions are determined by evaluating the changing states of the pressure switch in the time range of the changeover of the switch. In the region of the switching point, a so-called “switch bouncing” occurs, as a result of which a sequence of pulses having the amplitude of the control voltage (e.g., 5 V) is output. These pulses are then low-pass filtered or arithmetically averaged, resulting in a signal which is then made available as a quasi-analog instantaneous signal for the control or adjustment of the fan power. In other words, the signal that can be tapped off is a sequence of pulses which are produced by the bouncing of the vacuum switch during the changeover phase, and the sequence of pulses is filtered for a predetermined period of time in order to determine the actual value as a measure of the sensed vacuum.

Filtering, in particular low-pass filtering, of this signal results in smoothing of the signal, so that a signal proportional to the vacuum is obtained which can be used to adjust the power of a vacuum cleaner fan. By generating a signal proportional to the vacuum, the vacuum switch which, per se, only provides a purely digital output signal can be used like an analog vacuum sensor. This is achieved by smoothing the output signal of the vacuum switch.

Thus, in accordance with the approach proposed herein, a simple and inexpensive vacuum switch can be used in substantially the same way as a complex and, in particular, expensive analog pressure sensor in a control system for adjusting the power of a vacuum cleaner fan. The vacuum switch, together with its associated circuitry, then functions as an analog pressure sensor. This justifies that the vacuum switch and its associated circuitry for filtering its output signal are together sometimes referred to as “vacuum sensor” hereinafter.

In comparison with previous approaches which use a vacuum switch having exactly one switching point and attempt to maintain an operating point of the fan close to the switching point, more reliable control is achieved without the heretofore system-inherent swinging or at least low-frequency oscillation about the operating point. In general, the concept proposed herein can be used for any application that previously used conventional pressure sensors which monitored only one specific value. In accordance with the approach described herein, it is now possible to use inexpensive vacuum switches in such applications.

In an embodiment, a vacuum cleaner control system adapted to adjust the power of a vacuum cleaner fan is provided with a device for carrying out a method as described here and below. In an embodiment of the method, a value between a minimum value of the resulting signal and a maximum value of the resulting signal is provided as a setpoint to the control system for control. In any case, such a setpoint is within a measurement range of the vacuum sensor provided by the vacuum switch, which measurement range is bounded by the minimum value and the maximum value. In an embodiment of the method, the setpoint used for control is a value exactly in the middle between the minimum value and the maximum value. During control, the measurement range of the vacuum sensor provided by the vacuum switch is then optimally used.

In a further embodiment of the method, a lower threshold and an upper threshold are defined above the minimum value and respectively below the maximum value of the resulting signal of the vacuum sensor provided by the vacuum switch. When the instantaneous value of the signal picked up as an actual value for adjusting the power of a vacuum cleaner fan is between the lower and upper thresholds, a controller of the control system is activated which maintains the respective actual value close to the setpoint. When the instantaneous value is below the lower threshold or above the upper threshold, a controller is activated which brings the actual value at least back into a range between the two thresholds. This controller may be the same one onto which, for example, different amplification factors are imposed according to the respective location of the actual value. Alternatively, it is also possible to use at least two controllers in the control system and switch back and forth between them according to the respective location of the actual value.

In order to carry out an embodiment of the method, there is provided a control system intended for use in a vacuum cleaner. Such a vacuum cleaner control system adapted to adjust the power of a vacuum cleaner fan includes means which make it possible to carry out a method as described here and below.

The device provided for carrying out the method includes a vacuum switch having a single switching point and a filter provided in communication with the vacuum switch. The filter is electrically connected in parallel to the vacuum switch and filters a signal that can be tapped off above the vacuum switch.

In an embodiment of the control system, the filter is a low-pass filter. If the low-pass filter takes the form of an RC circuit, it is particularly simple in design, yet satisfies the purposes of the application presented here. A low-pass filter of this kind is inexpensive, and the filter characteristics can be easily defined and controlled by using a variable resistance and/or a variable capacitance.

In another embodiment of the control system, there is provided a plurality of series-connected vacuum switches which each have exactly one switching point. A filter for filtering the signal that can be tapped off above the series connection of vacuum switches is arranged electrically in parallel with the series connection of vacuum switches. Such a series connection of a plurality of vacuum switches makes it possible to extend the measurement range of the vacuum sensor so formed. Extension of the measurement range results in an extended value range within which the control system can maintain the resulting vacuum as close as possible to the predetermined setpoint by adjusting the power of the vacuum cleaner fan.

Overall, the present invention is also a vacuum cleaner having means for carrying out a method as described here and below. A control system having the features described here and below may be used as the means for carrying out such a method.

Altogether, the approach presented herein also proposes a novel use of a vacuum switch, namely the use of a vacuum switch together with a special circuitry associated therewith as a vacuum sensor. The vacuum switch concerned is one having a single switching point. The circuitry is special in that a filter is provided in communication with the vacuum switch and electrically connected in parallel therewith to filter a signal that can be tapped off above the vacuum switch. The filter may be, for example, a low-pass filter. The vacuum sensor so formed provides an analog sensor signal, which means that during operation of such a vacuum sensor, an analog sensor signal can be tapped off therefrom. According to the above-mentioned principle, such a vacuum sensor can be upgraded to one with extended measurement range by using a plurality of vacuum switches which each have different switching points. Instead of a plurality of vacuum switches which each have one switching point, it is then also possible to use one or more vacuum switches having a plurality of switching points. This relativizes the condition formulated throughout herein to facilitate the understanding of the description, according to which a vacuum switch having exactly one switching point or at least one vacuum switch having exactly one switching point is used. If more than one vacuum switch having exactly one switching point is used, then the use of one or more vacuum switches having a plurality of switching points is an equivalent embodiment which, in any case, is understood as being encompassed by the specification “a plurality of vacuum switches which each have exactly one switching point.”

An exemplary embodiment of the present invention is shown in the drawings in a purely schematic way and will be described in more detail below. Corresponding objects or elements are identified by the same reference numerals in all figures. The or each exemplary embodiment should not be understood as a restriction of the invention. Rather, variations and modifications which can be inferred by the person skilled in the art with regard to achieving the object for example by combination or modification of individual features or method steps that are described in connection with the general or specific part of the description and are contained in the claims and/or the drawings, and, by way of combinable features, lead to a new subject matter or to new method steps or sequences of method steps are also possible in the context of the present disclosure.

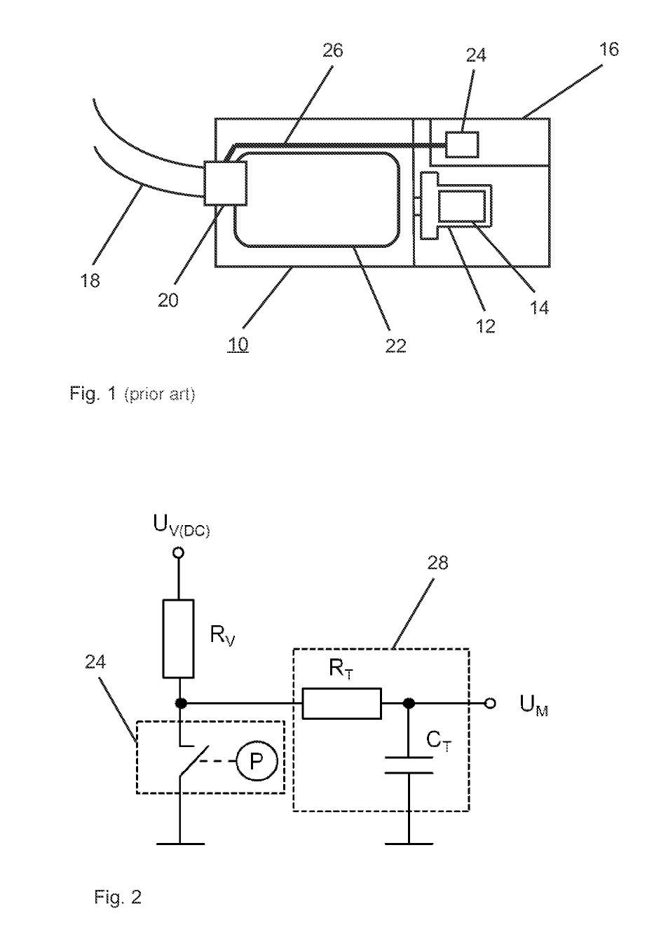

The view of FIG. 1 illustrates a vacuum cleaner 10 in a schematic block diagram, showing selected components. Accordingly, vacuum cleaner 10 includes a vacuum cleaner fan 12, also referred to in short as “fan”, which creates the vacuum necessary for the vacuuming process during the operation of vacuum cleaner 10. For purposes of adjusting the fan power of vacuum cleaner fan 12, the vacuum cleaner includes, in a manner known per se, a controllable fan motor 14. Vacuum cleaner 10 is provided with an electronic control system 16 for controlling fan motor 14. The electronic control system acts, for example via a power semiconductor device, on the power supply of the fan motor 14 by means of leading-edge or trailing-edge phase angle control. In this case, the phase angle is the manipulated variable of control system 16. Due to vacuum cleaner fan 12 and the vacuum created by it, a suction air stream is produced during the operation of vacuum cleaner 10. This suction air stream passes, in a manner known per se, from a floor nozzle through a suction hose 18 and a suction connector 20 adapted to connect suction hose 18 to the housing of vacuum cleaner 10, and into a dust bag 22.

The vacuum created by vacuum cleaner fan 12 is used as the controlled variable in control system 16. A vacuum switch 24 is provided to determine an indication of the vacuum pressure created during operation. The vacuum switch 24 used is one having a single switching point. In FIG. 1, vacuum switch 24 is shown as an element of control system 16 and is coupled via a vacuum hose 26 to the pressure conditions in the path of the suction air stream. In the embodiment shown, vacuum hose 26 leads from suction connector 20 to vacuum switch 24, so that vacuum switch 24 is coupled via a vacuum hose 26 to the pressure conditions in suction connector 20. Vacuum hose 26 is optional. Vacuum switch 24 may also be spatially directly associated with suction connector 20. Moreover, vacuum switch 24 may also be coupled to the vacuum conditions at a different point in the path of the suction air stream, either via a vacuum hose 26 or by suitably disposing the vacuum switch at the corresponding location. Accordingly, the location of vacuum switch 24 shown by way of example in FIG. 1 is irrelevant.

The view of FIG. 2 shows an example of the circuitry associated with vacuum switch 24 as proposed in the approach presented herein. Accordingly, vacuum switch 24 is connected via a dropping resistor RV to a DC voltage source and the supply voltage UV(DC) provided by the same. A low-pass filter 28, which, in the embodiment shown, takes the form of an RC circuit including a low-pass resistor RT and a low-pass capacitor CT, is connected to a center tap between dropping resistor RV and vacuum switch 24. The signal that can be tapped off above vacuum switch 24 can be tapped off in smoothed form at the output of a respective filter, here low-pass filter 28. The analog measured voltage value UM that can be tapped off therefrom is a measure of the vacuum pressure at that point in the path of the suction air stream to which vacuum switch 24 is coupled.

A simple vacuum switch 24 includes a flexible diaphragm which mechanically actuates a switch contact, an adjustable return spring, and a housing having one or more ports for attachment of vacuum hoses 26 or the like. A switching point of such a vacuum switch 24 is not of the snap-action type, but of the slow-action type. Because of this slow action, a slightly varying pressure close to the switching point results in bouncing of the switch contact. Due to this bouncing and the resulting, virtually uncontrolled opening and closing of the switch contact, a kind of a pulse-width modulation (PMW) pattern is produced.

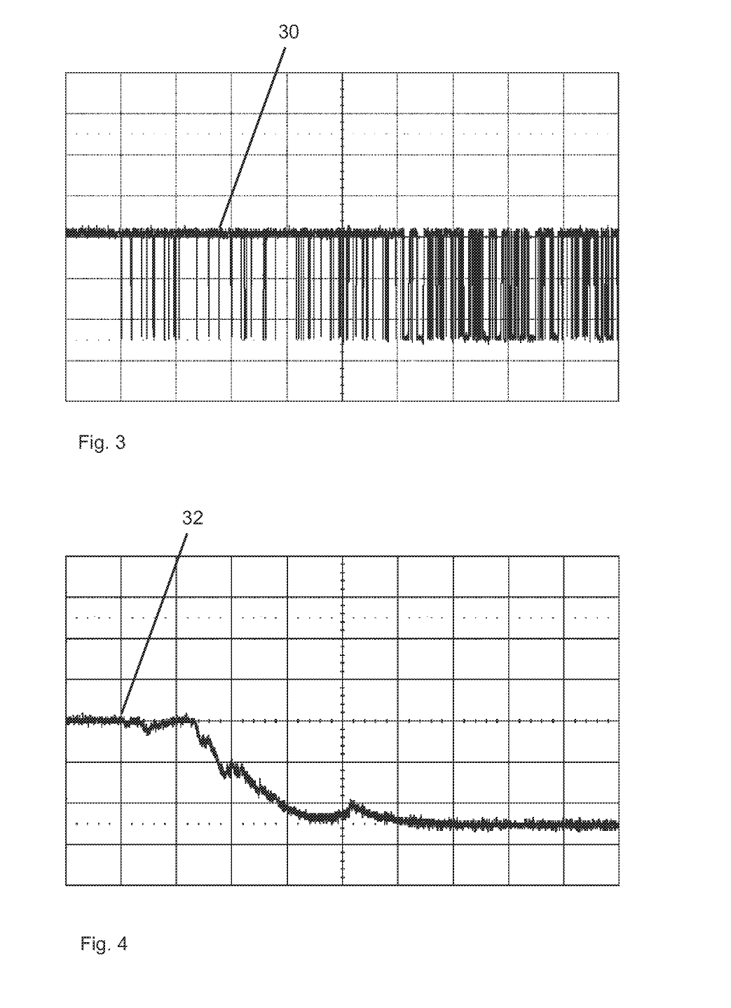

FIG. 3 shows an example of such a signal 30 recorded by an oscilloscope. If the circuitry associated with vacuum switch 24 is configured as illustrated by way of example in FIG. 2, signal 30 represents the waveform of the potential at the center tap between vacuum switch 24 and dropping resistor RV. The voltage that can be tapped off above vacuum switch 24 is plotted on the abscissa. The time is plotted on the ordinate.

Signal 30 is characterized in that the duration of the individual pulses is directly proportional to the pressure differential applied to vacuum switch 24. However, the signal pattern is not uniform, but, as it were, chaotic. By smoothing signal 30 by a filter, in particular a low-pass filter 28 (FIG. 2), an analog signal 32 can be generated from these switching operations. An example of such an analog signal 32 is shown in FIG. 4. If the circuitry associated with vacuum switch 24 is configured as illustrated by way of example in FIG. 2, signal 32 in FIG. 4 represents the waveform of the potential at the output of low-pass filter 28 (UM). The voltage (UM) that can be tapped off at the output of low-pass filter 28 is plotted on the abscissa. The time is plotted on the ordinate. If vacuum switch 24 is associated with a circuitry such as is illustrated by way of example in FIG. 2, then it becomes a vacuum sensor. Accordingly, the signal (UM) at the output of low-pass filter 28 is also referred to as “sensor signal 32”.

It should be noted at this point that the signal waveforms shown in FIG. 3 and FIG. 4 are not correlated in time. Thus, while the signal waveform shown in FIG. 4 is the result of the smoothing of a signal waveform at the output of vacuum switch 24, such as is illustrated in FIG. 3, it is not the result of the smoothing of exactly the signal 30 that is shown in FIG. 3, but of the smoothing of a signal that is tapped off at the output of vacuum switch 24 at a different point in time.

The sensor signal 32 of vacuum switch 24 obtained after smoothing can be fed as a controlled variable to an analog controller or subjected to analog-to-digital conversion and then fed to a digital controller. The controllers and control schemes (P control, PI control, PD control, PID control) that may be used are well known in the art and need not be specifically described herein. Such a controller forms part of control system 16.

Due to the relatively simple circuitry associated with vacuum switch 24, including a downstream filter, in particular a low-pass filter 28, a limited analog signal 32, which is a measure of the vacuum pressure in the path of the suction air stream, can be generated from the signal waveform across vacuum switch 24. The obtainable analog sensor signal 32 is limited because the observed bouncing of the switch contact of vacuum switch 24 and the resulting signal pattern occur only in the vicinity of its switching point.

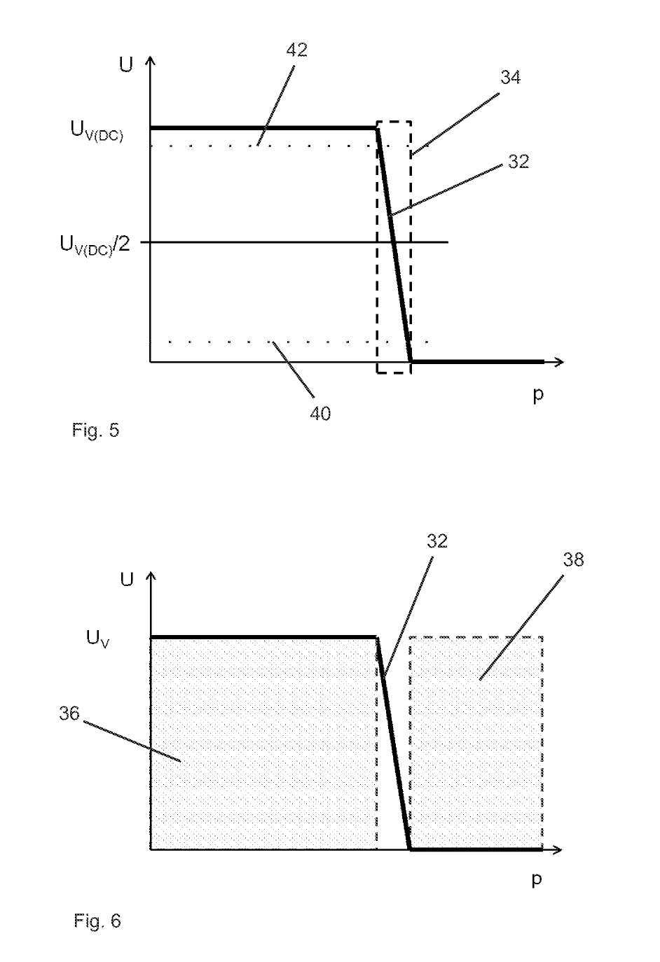

The limitation of the resulting sensor signal 32, hereinafter referred to as limited measurement range 34 (FIG. 5), is counterbalanced by the fact that the limited measurement range 34 lies exactly about the switching point of vacuum switch 24. Hence, control system 16 can then perform control all the more accurately within this range. This eliminates the need for complex evaluation algorithms, making it possible to use a simple controller that is optimized for the respective measurement range 34.

The view of FIG. 5 shows the position of the measurement range 34 of a vacuum switch 24 interconnected as illustrated in FIG. 2. Power p of vacuum cleaner fan 12 is plotted on the ordinate. The voltage (UM) that can be tapped off at the output of the vacuum switch 2 interconnected as illustrated in FIG. 2 is plotted on the abscissa.

Since the measurement range 34 of the sensor is quite narrow, the respective controller may perform control, for example, with a higher amplification factor outside the measurement range 34; i.e., in a first range 36 below measurement range 34 and a second range 38 above measurement range 34, and is thereby able to rapidly return to measurement range 34. The two ranges 36, 38 are shown in the view of FIG. 6.

A voltage value of ½ UV(DC) is input as a setpoint into control system 16 and the controller included therein (see FIG. 5). This setpoint lies at the center of measurement range 34. Control system 16 is capable of responding rapidly and accurately to deviations of sensor signal 32 from this setpoint. However, if sensor signal 32 leaves measurement range 34; i.e., if it falls below a predetermined or predeterminable lower threshold 40 or exceeds a predetermined or predeterminable upper threshold 42, then a different, higher amplification factor is used in control system 16. Instead of using a controller that uses a first (lower) amplification factor when sensor signal 32 is within measurement range 34 and a second (higher) amplification factor when sensor signal 32 is outside measurement range 34, it is also possible to switch back and forth between a first controller and a second controller. In this case, the first controller is activated when sensor signal 32 is within measurement range 34, and the second controller is activated when sensor signal 32 is outside measurement range 34. The two controllers may have different control schemes. For example, the second controller to be activated when sensor signal 32 is outside measurement range 34 may be a fast controller, such as, for example, a fast P-controller having a high amplification factor. Regardless of whether control system 16 is implemented with selectable controllers or with selectable amplification factors, control system 16 is in any case designed such that when sensor signal 32 is outside measurement range 34, the power p of vacuum cleaner fan 12 is corrected in such a way that sensor signal 32 is brought back into measurement range 34 between the two thresholds 40, 42. When sensor signal 32 is within measurement range 34, the power p of vacuum cleaner fan 12 is controlled in order to stay as close as possible to the predetermined setpoint.

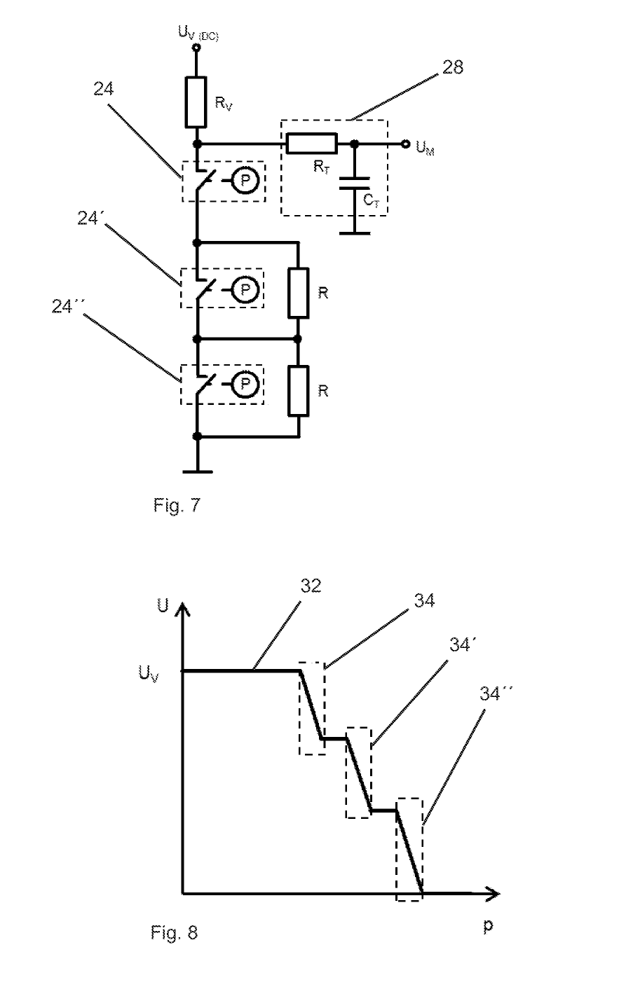

The view of FIG. 7 shows a suitable enhancement of the concept illustrated in FIG. 2. Instead of one vacuum switch 24, a plurality of vacuum switches, here three vacuum switches 24, 24′, 24′, may be used in a cascaded arrangement. Each vacuum switch 24, 24′, 24″ has a different switching point, so that when using the three vacuum switches 24, 24′, 24″ shown in FIG. 7, three measurement ranges 34, 34′, 34″ are obtained (FIG. 8), which are suitably cascaded in succession through suitable selection of the switching points of vacuum switches 24, 24′, 24″. This altogether results in an extended measurement range. Thus, such a cascaded arrangement of a plurality of vacuum switches 24, 24′, 24″ forms a vacuum sensor with extended measurement range according to the principle proposed herein. Instead of a plurality of vacuum switches 24, 24′, 24″ which each have exactly one switching point, it is also possible to use one or more vacuum switches which each have two or more switching points.

Thus, various salient aspects of the description given herein can be briefly summarized as follows: Disclosed are a method for adjusting the power of a vacuum cleaner fan 12, a control system 16 for implementing the method, and a vacuum cleaner 10 having such a control system 16. In accordance with the method, a signal 30 that can be tapped off above a vacuum switch 24 having a single switching point is smoothed by a filter 28, and the resulting signal 32 is processed by control system 16 like a sensor signal of an analog vacuum sensor for adjusting the fan power.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

10 vacuum cleaner

12 vacuum cleaner fan

14 fan motor

16 control system

18 suction hose

20 suction connector

22 dust bag

24 vacuum switch

26 vacuum hose

28 filter/low-pass filter

30 signal (output signal of the vacuum switch)

32 signal/sensor signal (output signal of the combination of the vacuum switch and the (low-pass) filter)

34 measurement range

36 first range (range below the measurement range)

38 second range (range above the measurement range)

40 lower threshold

42 upper threshold

What is claimed is:

1. A method of adjusting the power of a vacuum cleaner fan, the method comprising:
tapping off a signal via a vacuum switch having a single switching point;
filtering the tapped off signal to obtain a resulting signal, the resulting signal being a measure of the vacuum pressure created by the vacuum cleaner fan; and
using the resulting signal as a controlled variable for adjusting the fan power with an electronic control system.

2. The method as recited in claim 1, wherein the signal is filtered with a low-pass filter.

3. The method as recited in claim 1, wherein the tapped off signal includes a sequence of pulses, which are produced by the bouncing of the vacuum switch during a changeover phase, and wherein the sequence of pulses is filtered for a predetermined period of time to determine the resulting signal that is a measure of the vacuum pressure.

4. The method as recited in claim 1 further comprising providing a setpoint to the electronic control system for control, the setpoint being a value between a minimum value and a maximum value of the resulting signal.

5. The method as recited in claim 4 further comprising:
defining a lower threshold as above the minimum value of the resulting signal;
defining an upper threshold below the maximum value of the resulting signal;
activating a controller of the electronic control system to maintain the resulting signal close to the setpoint when an instantaneous value of the resulting signal is between the lower threshold and the upper threshold; and
activating a controller of the control system to bring the value of the resulting signal back into a range between the lower threshold and the upper threshold when the instantaneous value of the resulting signal is below the lower threshold.

6. An control system for a vacuum cleaner with a vacuum cleaner fan comprising:
a vacuum switch having a single switching point, the vacuum switch being configured to provide a tapped off signal;
a filter configured to filter the tapped off signal to obtain a resulting signal, the resulting signal being a measure of the vacuum pressure created by the vacuum cleaner fan; and
a controller configured to use the resulting signal as a controlled variable for adjusting the fan power.

7. The control system as recited in claim 6, wherein the filter is a low-pass filter.

8. The control system as recited in claim 6, wherein the filter is in communication with the vacuum switch, the filter and the vacuum switch being electrically connected in parallel.

9. The control system as recited in claim 6, wherein the filter includes an RC circuit.

10. The control system as recited in claim 6 further comprising a plurality of series-connected vacuum switches each having exactly one switching point, wherein the filter is arranged electrically in parallel with the series-connected vacuum switches.

11. A vacuum cleaner comprising:
a vacuum cleaner fan; and
an electronic control system comprising:
a vacuum switch having a single switching point, the vacuum switch being configured to provide a tapped off signal;
a filter configured to filter the tapped off signal to obtain a resulting signal, the resulting signal being a measure of the vacuum pressure created by the vacuum cleaner fan; and
a controller configured to use the resulting signal as a controlled variable for adjusting the fan power.

12. The vacuum cleaner as recited in claim 11, wherein the filter is a low-pass filter.

13. The vacuum cleaner as recited in claim 11, wherein the filter is in communication with the vacuum switch, the filter and the vacuum switch being electrically connected in parallel.

14. The vacuum cleaner as recited in claim 11, wherein the filter includes an RC circuit.

15. The vacuum cleaner as recited in claim 11 further comprising a plurality of series-connected vacuum switches each having exactly one switching point, wherein the filter is arranged electrically in parallel with the series-connected vacuum switches.
